(19) United States
(12) Patent Application Publication
(10) Pub. No.: US 2007/0010389 A1
(43) Pub. Date: Jan. 11, 2007

(54) Hands-free towel dispenser

(75) Inventors: Paul Cutrona, Woodbridge (CA); Graham Dickinson, Hamilton (CA); Stuart Evans, Victoria Harbour (CA); Brett Jermyn, Bobcaygeon (CA); Michael Whitby, Victoria Harbour (CA)

Correspondence Address: FISH & RICHARDSON PC, P.O. BOX 1022, MINNEAPOLIS, MN, 55440-1022, US

(73) Assignee: SCOTT PAPER LIMITED

(21) Appl. No.: 11/173,897

(22) Filed: Jul. 1, 2005

(51) Int. Cl. B23D 25/02

(52) U.S. Cl. 493/446; 83/337; 83/343; 83/649

(57) ABSTRACT

A novel dispenser for a paper product is provided. The dispenser comprises a feed and cut module that is oriented 90° relative to the width of a roll of web material. The dispenser is essentially hands-free. A method of dispensing a length of web material and a longitudinally folded paper product are also provided.

### FIELD OF INVENTION

The present invention relates generally to a dispenser apparatus, particularly to an apparatus for dispensing paper towels, more particularly, to a hands-free towel dispenser.

### BACKGROUND OF THE INVENTION

Paper towel dispensers are often provided in public bathrooms and also in other places, such as commercial kitchens and hospitals, where hand washing commonly occurs. Various types of dispensers are known in the art. In one type of device, a lever, push bar, or rotational knob is used to actuate the dispenser. Such dispensers often include a serrated edge against which the tail of the paper can be pulled to affect a tear.

Another preferred type of dispenser is a “hands-free” dispenser. This type of dispenser has been gaining popularity since there is no need for a user to touch surfaces that have been touched by a previous user. Thus, there is reduced risk of transfer of germs between users. In one type of dispenser, the process of dispensing and cutting the towel material is carried out by pulling on the free, or tail, end of the web material that extends from the paper towel holder and then ripping off a selected length of paper towel by tearing it along a serrated edge. The drum of such a device may include a drive mechanism which rotates the drum a predetermined degree in response to a pull on the web material by the user. Examples of this type of device can be found in U.S. Pat. Nos. 4,213,363, 4,635,837, 4,621,755, 4,846,035 and 4,122,738. A more recent example of this kind of device is described in United States Patent Application No. 2002/0073819.

Another type of paper towel dispenser comprises a stack of inter-folded towels. Again, the user pulls on the free end or tail end of a paper towel and as one paper towel is pulled out, the next paper towel in the stack is fed through the opening at the bottom of the container. Both of these types of devices require that the user pull on a paper towel with two wet hands. This may result in tearing of a paper towel, sometimes referred to as “wet tab failure”, since water reduces the strength of the towel.

Another type of hands-free towel dispenser is a towel dispenser that is electronically controlled. These types of towel dispensers may be triggered by proximity, light or motion sensors to detect when a towel is required. Examples of electronic towel dispensers can be found in U.S. Pat. Nos. 3,730,409, 3,971,607, 4,738,176, 4,796,825, 4,826,262, 4,796,825, 5,031,258, 5,060,323, 5,086,526, and 5,217,035. Further examples of microprocessor controlled hands-free paper towel dispensers can be found in United States Patent Application Nos. US 2004/0135027 and US 2005/0077419.

A problem with electronic dispensers is that they require a source of electricity such as AC current from a plug-in wall outlet to power the hands-free mechanism. Alternatively, batteries, photovoltaic cells or similar power sources can be used. However, all of these power sources require mechanisms that may be sensitive to water such as is commonly found in a washroom. Furthermore, electronic hands-free paper towel dispensers generally include complicated and expensive mechanisms that may be difficult to maintain.

Thus there was a need for a novel type of paper towel dispenser that would address the problems of wet tearing of a towel, the high maintenance required for an electronic dispenser, and complex mechanical design.

### SUMMARY OF THE INVENTION

The present invention addresses the problems of the prior art by providing a novel dispenser that provides a paper product that is crisply folded in half. The paper product of the invention is cut from a roll of web material. The paper product of the invention is unique in that it is folded along a crease line that is transverse to the width of the roll of web material. Folding doubles the thickness of the product at the point where the user grasps the tail.

In one aspect of the invention a dispenser for dispensing sheets from a roll of web material is provided. The dispenser comprises a roll holder and a feed and cut module that is oriented 90° to the width of the roll holder.

In a preferred embodiment the dispenser further comprises folding means for folding the web transverse to the orientation of the roll. A preferred folding means is a tapered mandrel.

In one embodiment the mandrel comprises a flattened cone shape.

In another embodiment the mandrel comprises an essentially triangular plane.

In yet another embodiment the mandrel comprises a triangular plane having a rectangular plane at the wide end.

In another preferred embodiment, the dispenser further comprises a tensioning system comprising a pair of rollers mounted on a frame.

The dispenser also preferably comprises a feed and cut system comprising a feed roller and a cutting cylinder aligned parallel to each other and 90° to the roll holder. A tail guide oriented in the same plane as the feed and cut system may also be included.

In one preferred embodiment, the dispenser comprises one roll holder. In another embodiment the dispenser comprises two roll holders.

The roll holder preferably comprises a bent metal rod having a cap at each end, said cap adapted to fit snugly into an end of a roll of web material. The housing preferably includes a pair of braces to engage the metal rod and prevent axial movement of the roll.

In a preferred embodiment the feed roller and the cutting roller are mounted side by side and the cutting roller comprises a translating blade. The blade has a raised bearing that rides in a cam path.

In another aspect of the invention, a method of dispensing a length of web material is provided. The method comprises:
a. inserting a roll of a web material on a roll holder;
b. feeding a free end of said roll between two tensioning rollers;
c. pulling the web over a tapered mandrel to fold the web wherein the fold line is transverse to the width of the roll; and
d. cutting the folded web at a predetermined length.

The invention also provides a dispenser for dispensing sheets of web from a roll of web material. The dispenser comprises:
a. a housing having a dispensing slot;
b. at least one roll holder disposed within the housing to hold a roll of web material;
c. at least one tensioning system proximal to said roll holder;
d. at least one tapered mandrel following the tensioning system; and
e. a feed and cut system at the tapered end of the mandrel, said feed and cut system comprising a pair of rollers oriented 90° to the roll holder.

In another aspect of the invention a folded paper product is provided. The paper product is folded transverse to the width of a roll of web material.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a perspective view of one embodiment of a dispenser according to the invention;

FIG. 2 illustrates the embodiment of FIG. 1 wherein the roll holder has been pivoted up;

FIG. 3 illustrates the holder with a roll of web material and the web material being fed through the system;

FIG. 4 illustrates how the web is folded over the mandrel;

FIGS. 4A and 4B illustrate the web as it is folded and fed into the feed and cut system;

FIG. 5 illustrates the folded web as it is fed through the feed and cut system;

FIG. 6 illustrates the cutting wheel with a blade;

FIG. 7 illustrates the translation of the blade as it travels through a cam path;

FIG. 8A illustrates the blade cutting the web material;

FIG. 8B is a perspective view illustrating the cutting of the web;

FIG. 9 illustrates a cut segment of the web being dispensed through an opening; and

FIG. 10 illustrates another embodiment of the invention that comprises two roll holders.

### DETAILED DESCRIPTION

The present invention provides a dispenser for paper products that has low maintenance requirements due to a minimum of moving parts. The dispenser comprises a cutting module oriented 90° to a roll holder. The invention also provides a novel method of providing the product to the user. The invention further comprises a novel paper product that is folded along an axis that is rotated 90° relative to the width of a roll of web material from which it is derived.

As used herein, the term “paper product” means a product derived from a woven web. This product may be a drying towel for hands, a kitchen towel, a bathroom tissue, a facial tissue or other products that are suitable for wiping or drying.

The term “hands free” is used herein to refer to a dispenser that does not require the user to touch any surface parts.

The term “dispenser” is used herein to refer to a device that provides a predetermined amount of a paper product.

According to one aspect of the invention, a folded paper product is provided to a user. The paper product is folded vertically so that the surface provided to the user is half the width of an unfolded segment of paper. The user pulls the product along the fold line which is the strongest segment. This reduces the incidence of wet tab failure whereby a paper product loses integrity when pulled with wet hands.

The dispenser of the invention comprises modular components that can easily be replaced. If one of the modules is in need of repair or if a particular module is updated, the component module can be replaced without the need to replace the entire dispenser. The dispenser typically comprises a roll holder module, a tensioning and folding module and a feed and cut module.

The roll holder module comprises a holder for a roll of web material and means for preventing axial movement of the roll. Axial movement can be restricted by using spring loaded ends or braces that hold the clasping ends of the holder in position. The tensioning and folding modules comprises means for maintaining the web under tension and means for initiating a transverse fold. The feed and cut module comprises a feed roller and a cutting cylinder. The feed and cut module is oriented 90° relative to the roll of web material. The free end of the web material is folded and fed through the feed and cut module where a segment or sheet is cut and dispensed. Depending on the starting orientation of the roll of web material (i.e. width facing user or end facing user), the sheet of web material will be presented with the fold facing the user or with the fold on the side.

In a preferred embodiment the free end of the web material is fed from the roll into a tensioning module. The tensioning module typically comprises a pair of rollers. The rollers may be aligned along their length or they may be offset. The web material is fed under the first roller and over the second roller. The first and second roller may have the same or different diameters. The web material is then folded over a tapered mandrel to provide a web that is folded lengthwise. While a tapered mandrel is one way to fold a web, other folding mechanisms known to those skilled in the art can be used to provide a folded web. In addition, various types of tapered mandrel are encompassed within the invention. For example, a cone or flattened cone can be used. Alternatively, the mandrel may comprise an equilateral triangle plane or an isoceles triangle plane. The mandrel may include a rib to facilitate folding.

The web is folded essentially in half, not necessarily exactly in half. The web may be folded in half so that the two edges are next to each other. Preferably, the web is folded slightly off-centre so that one side edge overlaps the other. When the fold is off-centre, it is easier to unfold the sheet of web material.

The folded web is fed into the feed and cut module that comprises a feed roller and a cutting cylinder. The feed roller and the cutting cylinder are oriented in the opposite direction to the roll of web material since folding of the web changes the predominant plane of the web material. The feed roller and the cutting cylinder rotate towards each other to feed the folded web through a dispensing slot in the housing. As a user pulls on the tail of web material, the cutting cylinder rotates and a blade cuts the web. Preferably a translating blade that travels in a cam path is used. It is apparent, however, that various types of cutting mechanisms known for cutting a web of material can be used. Various types of blades, such as straight, curved, angular or serrated can be used. The blade cuts the web at a predetermined length. The dispenser preferably includes a tail guide that ensures that an appropriate length of tail is fed through the dispensing slot to be ready for the next user. An emergency feed knob is optionally included in case the tail is not properly fed into the slot. The emergency knob is preferably made of a material such as stainless steel that does not promote growth of microorganisms.

One advantage of the present invention is that, under normal circumstances, there is no need for a user to touch any part of the dispenser to obtain the paper product. This reduces the risk of transmission of infections or toxic agents from one user to another.

Another advantage of the present invention is that it is modular in design. Thus, one component, such as the roll holder or the mandrel, for example, can be easily replaced. This eliminates the need to provide a complete replacement dispenser and also significantly reduces the amount of down time.

A further advantage of the dispenser of the present invention is that folding of the web essentially doubles the strength of the paper product. This decreases the probability of tearing or wet tab failure. This also allows for the use of lighter weight webs.

Yet another advantage of the dispenser of the invention is that it can accommodate a large roll of web material or more than one roll of web material. This reduces the need for frequent loading.

The components of the dispenser can be manufactured using various processes and various materials.

Plastic injection molding (PIM), reaction injection molding (RIM), metal injection (MIM), vacuum forming (VF), and metal stamping (MS) procedures are appropriate manufacturing processes. For material selection, low carbon steel (CS), stainless steel (SS), polycarbonate (PC), polystyrene (PS), polyethylene (PE), and nylon have been used.

The holder is preferably constructed of a bent steel rod and two nylon caps. The holder is subjected to stresses caused by the rotation of the paper towel. Since the holder restricts axial movement due to the positioning of the locking braces, the properties acquired by using injection molded nylon caps and bent steel rod arms are highly efficient and cost-effective. The two tensioning rollers and their holding brackets are preferably manufactured from PC by PIM.

The tail guide, mandrel and rollers may either be made via PIM, MIM, VF, or stamping using PC, SS, PS, or CS respectively for material selection. All four processes are associated with relatively inexpensive manufacturing costs. The tail guide is preferably manufactured by VF and produced from PC because of the low costs. The mandrel is preferably made from PS by means of VF. The preferred mandrel is simple enough be completely vacuum formed. The cutting mechanism is preferably made of CS because of its high strength. The rollers are preferably manufactured via PIM due to its ability to produce intricate shapes using PC.

In preferred embodiments, metals are used where possible in the dispenser to reduce costs, and increase functional life and durability. The back of the housing is preferably stamped from CS. Attaching the back of the case to the wall and inserting the dispenser internal modules makes for easy installation of the dispenser. A metal case back is preferable since it is harder to vandalize than plastic cases.

Elastomer coverings are preferably used on all of the cylindrical rollers to increase roller efficiency. Elastomer covered rollers offer many advantages to the web feeding process. Elastomers have a high coefficient of friction making them ideal for feeding, or driving the web without tearing it. They recover quickly from deformation, decreasing the possibility of the web being ripped apart. Furthermore, the web will have a lower tendency to slide back and forth from its path because of the high frictional properties of elastomers. Elastomer roller coverings can be manufactured from a number of different plastic compounds. These include hypalon, Buna N, EPDM, silicone, neoprene, urethane and Teflon.

The following description is of a preferred embodiment.

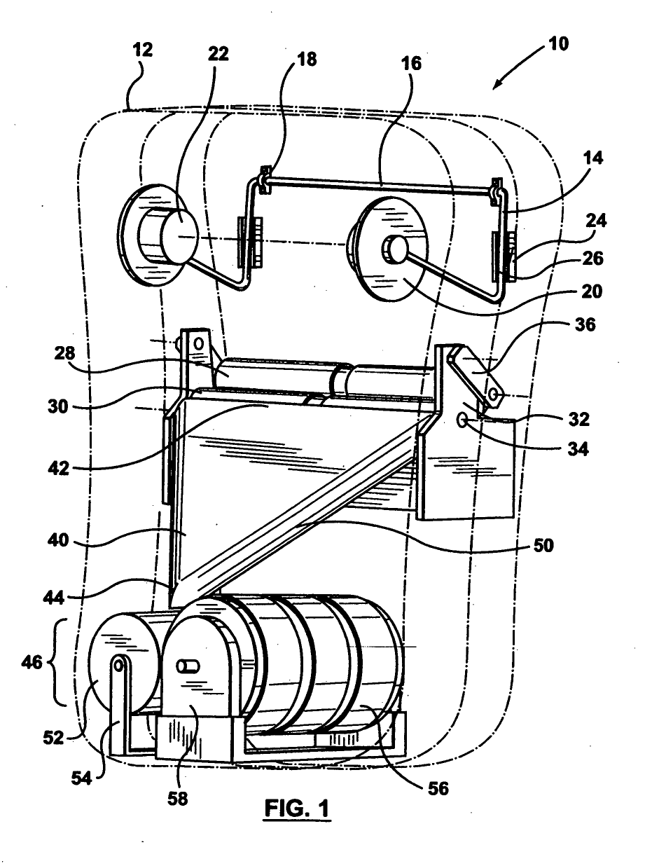

Referring now to the figures, a preferred embodiment of a dispenser according to the invention is illustrated. FIG. 1 illustrates a dispenser 10 which comprises a housing 12. While a particular housing shape is shown, it is clearly apparent that variations in design of the housing can be implemented without departing from the invention. Within the housing, a roll holder 14 is attached. The roll holder is preferably a bent metal rod 16 that is mounted using clips 18 that allow the metal rod to rotate. Each end of the bent rod typically includes a cap 20 that has a protrusion 22 adapted to fit inside the end of a roll of web material. A pair of braces 24 mounted on the housing hold the sides 26 of the metal rod in position to prevent lateral movement of the holder.

Following the roll holder is a tensioning system 26 that is designed to maintain the web material taut. The tensioning system typically comprises a first roller 28 and a second roller 30 mounted on a frame 32. The second roller 30 is mounted via a pin 34 to rotate on the frame 32 and the first roller 28 is mounted to the frame using a pivoting arm 36. Both rollers are preferably surfaced with a friction promoting material.

Also attached to the frame is a tapered mandrel 40. The wide end 42 of the mandrel is attached to the frame and the narrow end 44 of the mandrel feeds into a feed and cut module 46. In the illustrated embodiment the mandrel comprises a generally triangular plane with a rectangular plane (not seen) attached at the wide end. The mandrel also includes filleted sides 50. Other types of mandrels useful in the invention include a cone, a flattened cone or a triangular plate. The purpose of the mandrel is to guide the web to be folded essentially in half. As used herein, the term mandrel is used to encompass other mechanisms for promoting folding as equivalents in the invention.

The mandrel feeds into a feed and cut module 46. The feed and cut module comprises a feed roller 52 mounted on a feed bracket 54 and a cutting cylinder 56 mounted on a bracket 58. The feed and cut module is oriented 90° relative to the roll of web material.

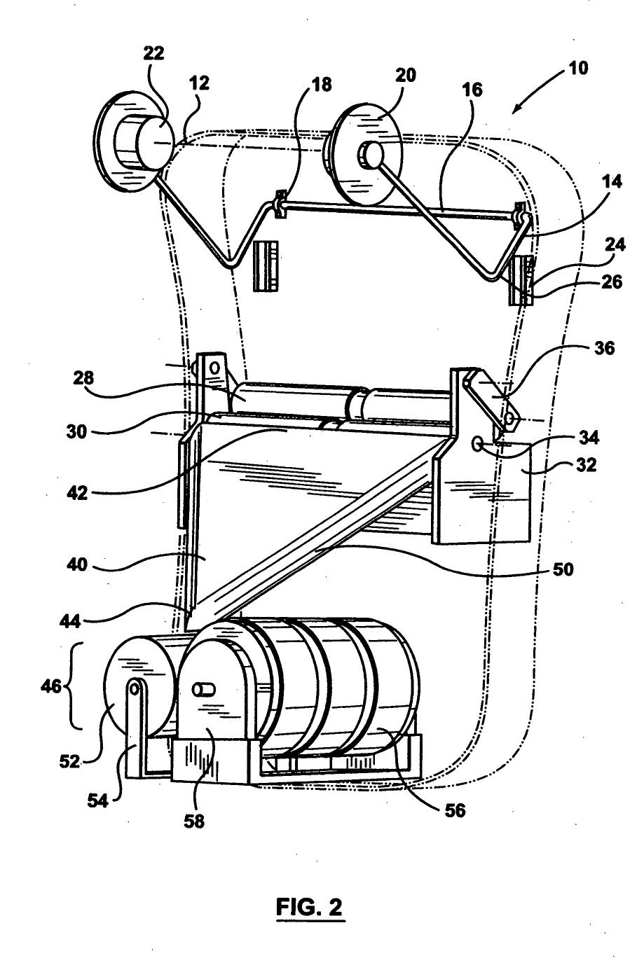

FIG. 2 illustrates how the roll holder 14 can be raised for easy loading of a roll of web material. The sides 26 of the bent rod are released from the braces 24 and the rod 16 is rotated upwards.

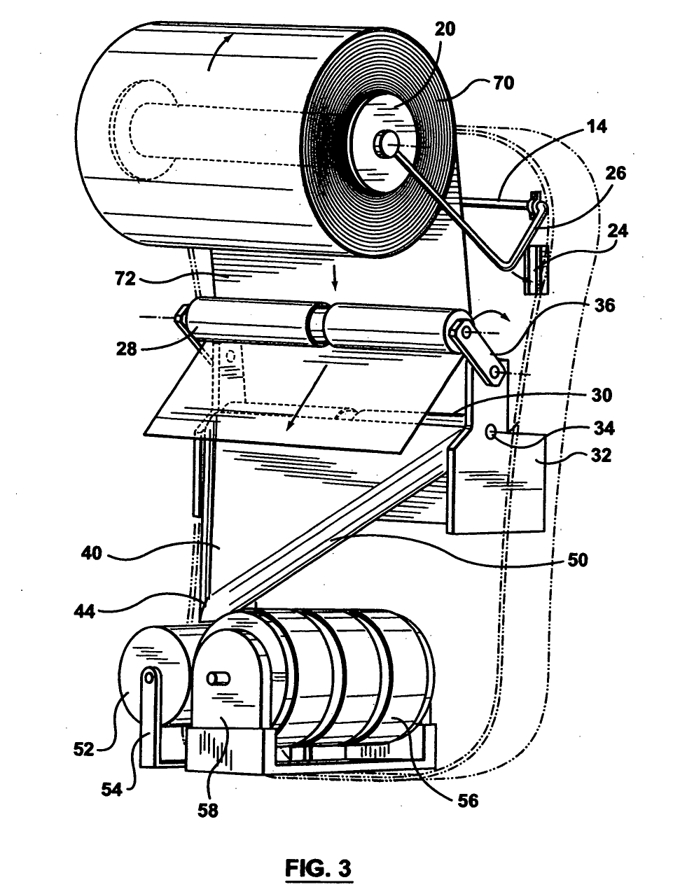

FIG. 3 illustrates how a roll of web material 70 is loaded into the dispenser. The roll holder 14 is lifted and the roll of web material is clamped between the caps 20 at the end of the bent rod holder. A web 72 from the roll is fed from the roll of web material under the first roller 28 and over the second roller 30 of the tensioning system. As can be seen in FIG. 3, the second roller 30 can be pivoted up using the pivot arm 36 to allow the web to be easily placed between the rollers. The second roller is then rotated down so that the web is held between the two rollers.

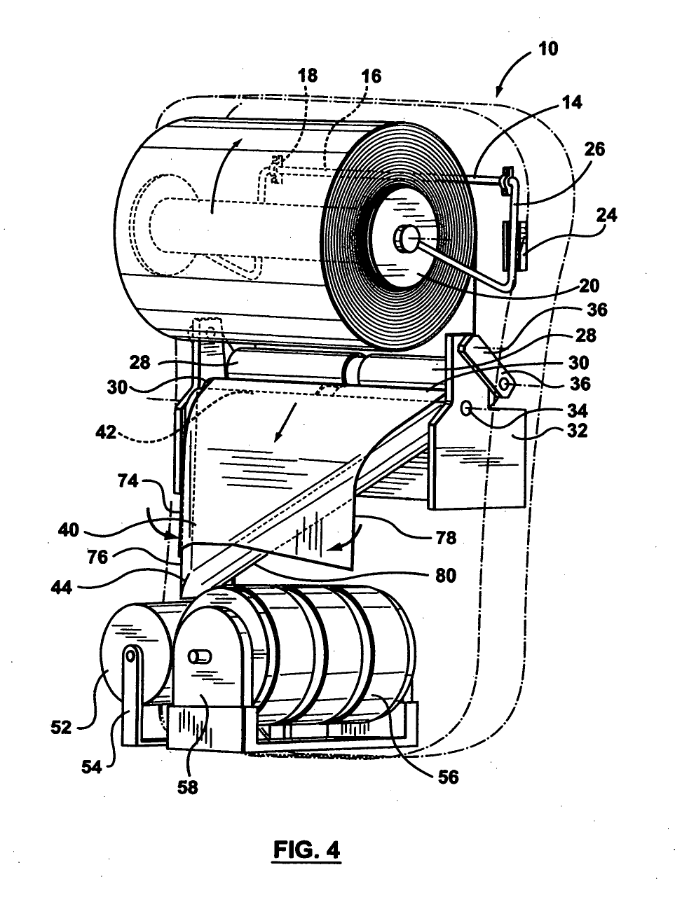

Referring now to FIG. 4, the roll holder 14 is clamped in the braces 24 to firmly hold the roll of web material in position and to prevent axial movement of the roll. The first roller 28 of the tensioning system has been pivoted back into position and the web 72 is held taut between the two rollers 28, 30. The web 72 is then pulled, under tension, over the mandrel 40. The left side 74 of the web is folded over the left side 76 of the mandrel and the right side 78 of the web is folded over the right side 80 of the mandrel.

FIGS. 4A and 4B are top views illustrating the mandrel feeding into the feed and cut module.

FIG. 4B illustrates in dotted lines the free sides 74, 78 of the web folded over the rear of the mandrel. As the web is folded over the mandrel, a centre crease 82 is formed as the web is folded essentially in half. It should be clearly understood that the while the web is folded, it is not necessarily folded exactly in half. In a preferred embodiment the crease is slight offset so that one free side of the web overhangs the other free side of the web.

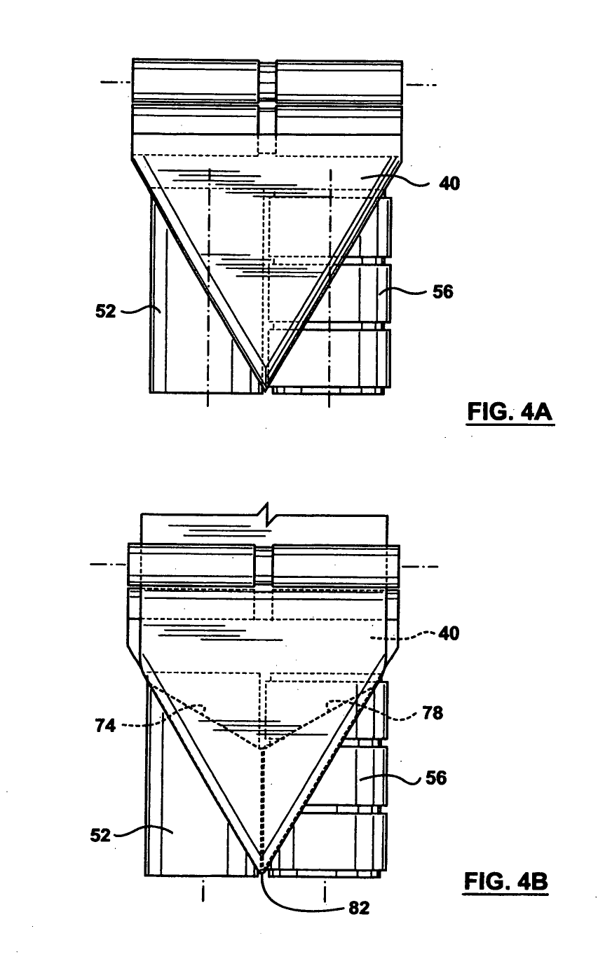

FIG. 5 illustrates how the web 72 is folded over the mandrel and then fed into the feed and cut module. Because the web is folded, the feed and cut rollers are mounted in the opposite direction (i.e. 90°) to the roll of web material. The folded web 81, having a crease 82 and left and right sides 74, 78 respectively, passes between the feed roller 52 and the cutting cylinder 56. A folded web is then fed out through a dispensing slot in the bottom of the housing.

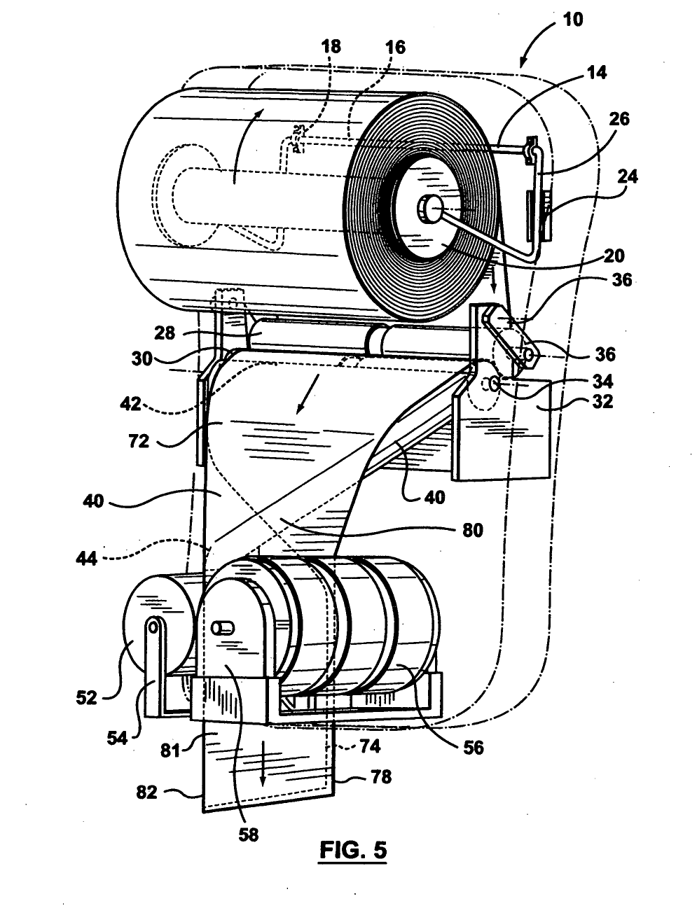

FIG. 6 illustrates how the web 72 is fed from the mandrel 40 to between the feed roller 52 and the cutting cylinder 56 as they rotate in opposite directions. The feed roller 52 and the cutting cylinder 56 are positioned next to each other and have parallel axes of rotation. The roller and/or cylinder preferably have a surface that creates friction between the web and the surface. This may be achieved, for example, by using an elastometric surface, by applying hatching to the surface, or other methods that promote friction. The folded edge or crease 82 can be seen as it passes between the rollers. A tail guide 88 directs the folded web through a dispensing slot 90 in the housing.

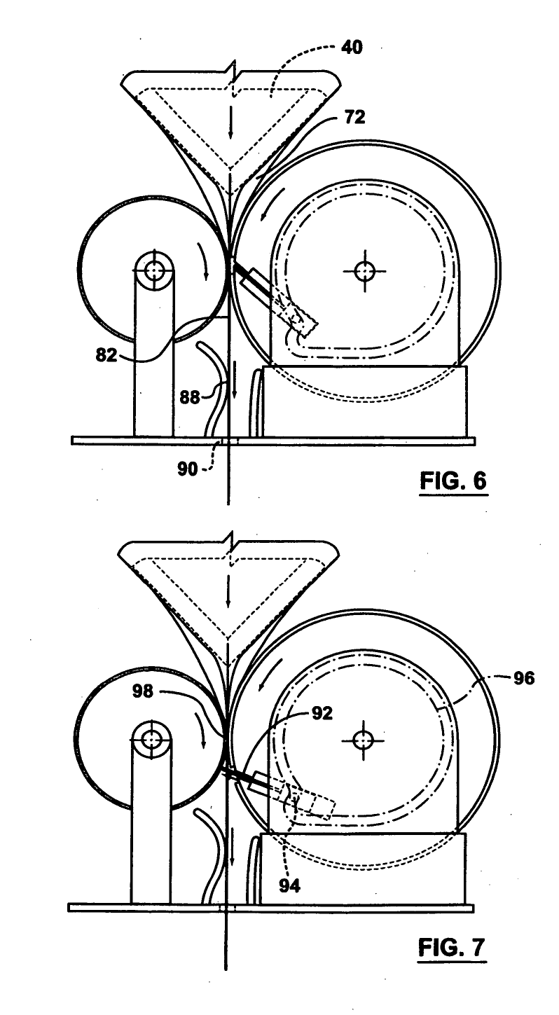

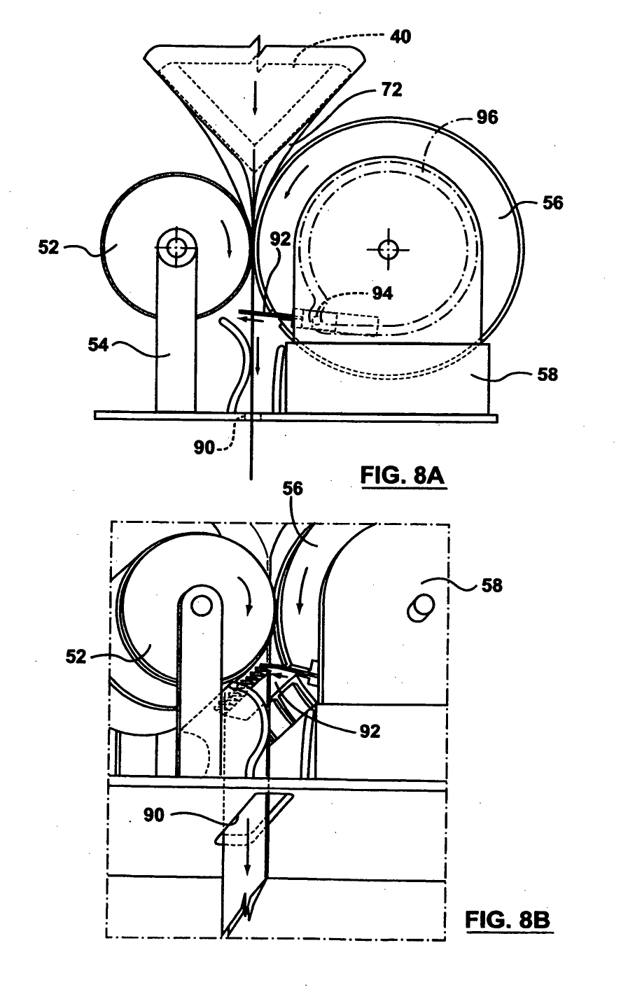

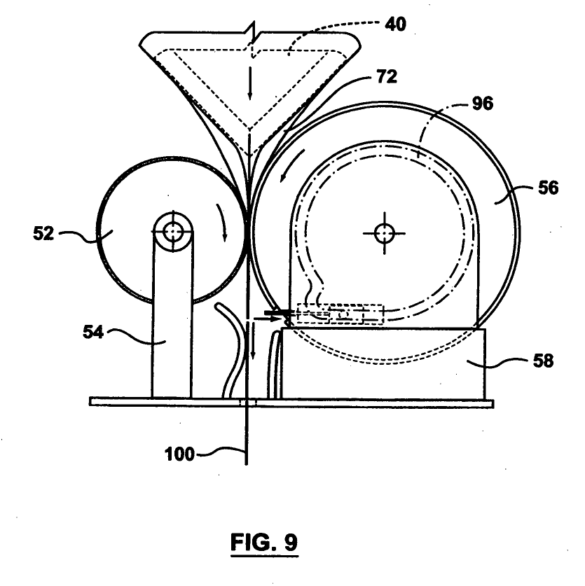

As the web is fed between the feed roller and the cutting cylinder, a translating blade 92 cuts the web at a predetermined length as shown in FIG. 7. In a preferred embodiment, the blade 92 has a raised bearing 94 that rides in a cam path 96. The blade 92 cuts the web 72 below the point of contact 98 between the roller and the cylinder and thus, feeding occurs independently of cutting. This can be seen further in FIGS. 8A and 8B. As shown by the arrow, the blade advances from the cutting cylinder to sever the web so that a predetermined length of web is dispensed to a user. The tail guide 88 ensures that the cut end of the web is directed to the dispensing slot. FIG. 9 illustrates how the blade is retracted as the roller and cylinder continue to turn. A cut sheet 100 of folded web material is dispensed. The completed rotation feeds a tail of appropriate length through the dispensing slot. When this tail is pulled by the next user, the feed and cut system is again actuated.

In another preferred embodiment, the dispenser comprises two roll holders. This configuration increases efficiency and requires less frequent re-loading of the dispenser. In the illustrated embodiment, the two webs are fed through separate tensioning systems and mandrels to a single cut and feed system. In another embodiment, a nub roll is used to replace a nearly depleted roll with a new roll. As the first roll is nearly depleted, the tail of the second roll is picked up and fed through the system together. When the first roll is depleted the second roll will continue to fed through the system. Various types of mechanisms for roll switching such as those used for toilet paper rolls can be adapted for use in the present invention. The two rolls may be inserted side by side or one above the other. They may be oriented with the ends facing a user or with the web surface facing the user.

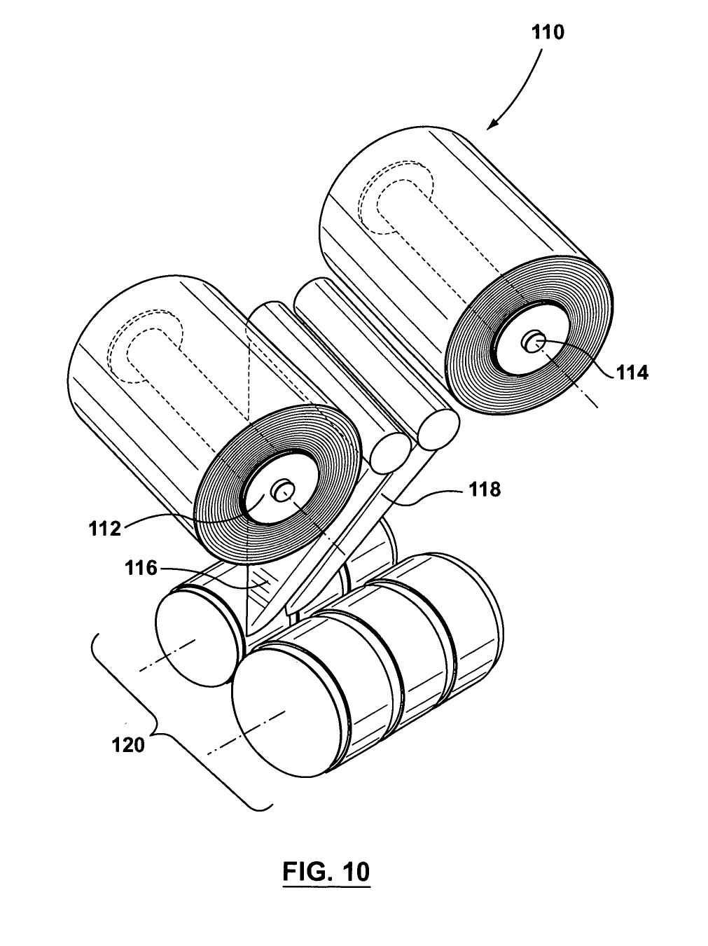

Referring to FIG. 10, an embodiment of a multi-roll dispenser is shown. The dispenser 110 comprises a first roll holder 112 and a second roll holder 114. In this embodiment, a first mandrel 116 and a second mandrel 118 receive a length of web from the first and second holder, respectively. Both webs feed into a common feed and cut module 120. As the first roll is consumed, the second mandrel drops into position to feed the second, full roll into the feed and cut module.

All citations are hereby incorporated by reference.

The present invention has been described with regard to one or more embodiments. However, it will be apparent to persons skilled in the art that a number of variations and modifications can be made without departing from the scope of the invention as defined in the claims.

What is claimed is:

1. A dispenser for dispensing sheets from a roll of web material comprising a roll holder and a feed and cut module wherein the feed and cut module is oriented 90° to the roll holder.

2. A dispenser according to claim 1 further comprising folding means for folding the web transverse to the orientation of the roll.

3. A dispenser according to claim 2, wherein the folding means is a tapered mandrel.

4. A dispenser according to claim 1, further comprising a tensioning module comprising a pair of rollers mounted on a frame.

5. A dispenser according to claim 2 further comprising a feed and cut module comprising a feed roller and a cutting cylinder aligned parallel to each other and 90° to the roll holder.

6. A dispenser according to claim 5, further comprising a tail guide oriented in the same plane as the feed and cut system.

7. A dispenser according to claim 5, comprising one roll holder.

8. A dispenser according to claim 5, comprising two roll holders.

9. A dispenser according to claim 5, wherein the roll holder comprises a bent metal rod having a cap at each end, said cap adapted to fit snugly into an end of a roll of web material.

10. A dispenser according to claim 9, wherein the dispenser comprises a housing having a pair of braces to engage the metal rod and prevent axial movement of the roll.

11. A dispenser according to claim 5, wherein the tensioning system comprises a pair of rollers.

12. A dispenser according to claim 11, wherein the pair of rollers are offset.

13. A dispenser according to claim 12, wherein the rollers are in line with each other.

14. A dispenser according to claim 13, wherein the rollers have a friction promoting surface.

15. A dispenser according to claim 5, wherein the mandrel comprises a flattened cone shape.

16. A dispenser according to claim 5, wherein the mandrel comprises an essentially triangular plane.

17. A dispenser according to claim 5, wherein the mandrel comprises a triangular plane having a rectangular plane at the wide end.

18. A dispenser according to claim 16, wherein the mandrel includes filleted edges.

19. A dispenser according to claim 16, wherein the triangular plane includes a crease initiation raised spine.

20. A dispenser according to claim 5, wherein the rollers of the feed and cut module comprises a feed roller and a cutting roller each mounted on a frame.

21. A dispenser according to claim 20, wherein the feed roller and the cutting roller are mounted side by side.

22. A dispenser according to claim 21, wherein the cutting roller comprises a translating blade.

23. A dispenser according to claim 22, wherein the blade has a raised bearing that rides in a cam path.

24. A dispenser according to claim 6, wherein the tail guide comprises a pair of parallel plates.

25. A method of dispensing a length of web material, said method comprising:
i. inserting a roll of a web material on a roll holder;
ii. feeding a free end of said roll between two tensioning rollers;
iii. pulling the web over a tapered mandrel to fold the web wherein the fold line is transverse to the width of the roll; and
iv. cutting the folded web at a predetermined length.

26. A dispenser for dispensing sheets of web from a roll of web material, said dispenser comprising:
i. a housing having a dispensing slot;
ii. at least one roll holder disposed within the housing to hold a roll of web material;
iii. at least one tensioning system proximal to said roll holder;
iv. at least one tapered mandrel following the tensioning system; and
v. a feed and cut system at the tapered end of the mandrel, said feed and cut system comprising a pair of rollers oriented 90° to the roll holder.

27. A paper product derived from a roll of web material, said paper product comprising a fold transverse to the width of the web material, whereby the product is folded essentially in half.

28. A paper product according to claim 27 selected from the group consisting of facial tissue, bathroom tissue, kitchen towel and hand drying towel.
